(19) United States
(12) Patent Application Publication
(10) Pub. No.: US 2008/0245611 A1
(43) Pub. Date: Oct. 9, 2008

(54) Self-Belay And Rappel Device And Methods Of Use

(76) Inventor: Gregory Lee Klingler, Denver, CO (US)

Correspondence Address: GREGORY LEE KLINGLER, 824 E. IOWA AVE., DENVER, CO, 80210, US

(21) Appl. No.: 11/697,722

(22) Filed: Apr. 7, 2007

(51) Int. Cl. A62B 1/20

(52) U.S. Cl. 182/6; 182/5; 188/65.2

(57) ABSTRACT

A Self-Belay And Rappel Device (10) is presented which will arrest the fall of a climber who is solo lead climbing, and will also allow the climber to rappel down a Rope (36). The simple and inexpensive device comprises a Left Side Face (12), a Right Side Face (14), Cylindrical Stand-Offs (16) which separate and join to the two side faces, and a Brake Surface (18) extending between the two side faces. In use for fall arrest, the device is attached, using two karabiners, both to a climber's chest harness and to the climber's waist harness. A third karabiner is clipped through two slots in the device, one slot in each of the two side faces. The fall of a climber causes the third karabiner to be pulled up within the two slots, ultimately locking the device against the climber's Rope (36) by causing the Rope (36) to become pinched between a portion of the third karabiner and the Braking Surface (18). The addition of a Sling (50) will allow the climber to rappel down the Rope (36) even if the climber has come to rest suspended in mid-air after a fall.

### CROSS-REFERENCE TO RELATED APPLICATIONS

Not applicable.

### STATEMENT REGARDING FEDERALLY SPONSORED RESEARCH AND DEVELOPMENT

Not applicable.

### BACKGROUND

1. Field of Invention

This invention pertains to, but is not limited to, the mountaineering art and more specifically to a self-belay and rappel device for solo climbers.

2. Description of Prior Art

In the sport of rock climbing, a belay device is used to protect a climber from injury in the case of a fall. Generally the climber wears a harness to which one end of a rope is attached. The rope passes through a belay device that is often attached to the harness of another person, the “belayer”. The belayer operates the belay device and typically remains at a stable point while the climber ascends. When the climber is “lead” climbing, the climber drags the rope up the rock as he ascends. At various points during the ascent, the climber clips the rope into metal loops (karabiners) that, in turn, are attached to the surface of the rock. When the climber is “top-rope” climbing, the rope extends down toward the climber from above. In the case of lead climbing, the belayer feeds out rope as the climber ascends. In the case of top-rope climbing, the belayer takes in rope as the climber ascends. In either case, if the climber falls, the belayer must grasp the rope securely by means of the belay device. The fall is therefore stopped by means of the belay device and the climber comes to rest suspended from above by the rope. Thereafter, the belayer may gently lower the climber to the ground by operating the belay device so as to gradually release tension on the rope. Anyone experienced in rock climbing is familiar with this practice and with the various forms of belay devices.

The simplest, most common, belay device is made up of a solid piece with one or two oval passages and a containment loop. The version with two oval passages can handle two ropes simultaneously. In use, a loop of rope is threaded through the oval passage and a karabiner is clipped through the rope loop as well as the containment loop. The karabiner is also attached to the harness of a belayer. When a climber falls, the rope passing through the oval passage causes the karabiner to be pulled against the surface of the solid piece. The oval passage opening is dimensioned so as to constrain the rope when the karabiner is pulled against it. These devices provide friction to slow the rope, but they all require the belayer to provide additional braking force in order to stop the rope. An example of this simple type of belay device is the ATC Climbing Belay Device by Black Diamond Equipment Ltd. of Salt Lake City, Utah.

Another class of belay devices, auto-locking belay devices, generally consists of relatively more complicated designs, often with moving parts, which have the benefit of requiring no action on the part of a belayer in order to stop a fall. An example of this class of auto-locking devices is found in U.S. Pat. No. 5,577,576 to Petzl et al. which has been commercially introduced as the GriGri Climbing Belay Device by Petzl of Crolles, France.

One sub-class of auto-locking belay devices consists of devices produced specifically for solo lead climbing in which the climber climbs alone without the assistance of another person. In solo lead climbing, the climber anchors a rope at the bottom of the climb and attaches the belay device directly to his harness. As the climber ascends, the free side of the rope is pulled through the belay device by the anchored side of the rope. The climber periodically clips the anchored side of the rope to the rock surface.

A commercial example of a belay device for solo lead climbing is the Soloist produced by Wren Industries of Grand Junction, Colo. Information about the Soloist can be found on the company's website, www.wrenindustries.com. A positive aspect of the soloist is that it will lock the rope almost immediately when a climber falls. The Soloist is a directional device in that it will lock a rope if a fixed end of the rope is pulled upwards with respect to the device, but will allow the rope to pass if the fixed end of the rope is pulled downward with respect to the device. A negative aspect of this directional device is that a climber must maintain a generally upright orientation during a fall in order for the device to work properly. If a climber falls upside down, it is possible that the device will not lock and will therefore not arrest the fall. A second negative aspect of the Soloist is that it is a relatively expensive device, with a suggested retail price of $105.00. A third negative aspect of the Soloist is that it can be cumbersome to thread rope through the device, especially when attempting to do so from a precarious position on the side of a mountain. The Soloist has a cam that rotates to lock the rope when a climber falls. The cam is held in place by a special pin. To position the device on a rope:
(i) the rope must be placed within the device,
(ii) the cam must then be paced within the device in front of the rope,
(iii) two holes, one in each side of the device, must be exactly aligned with a hole that passes through the cam, a difficult procedure given that the cam is not easily held when within the device,
(iv) the special pin must be placed through all three holes and fixed in position. A fourth negative aspect of the Soloist is that, although it can be configured to allow a climber to rappel, to do this function it must be threaded with rope differently than when be used to arrest a fall. Therefore, if a climber has fallen and has come to rest suspended in mid-air from an overhanging clip, the climber cannot lower himself without the aid of additional equipment.

A second commercial example of a belay device for solo lead climbing is the Silent Partner, also produced by Wren Industries of Grand Junction, Colo. Information about the Silent Partner can be found on the company's website, www.wrenindustries.com. The Silent Partner is protected under U.S. Pat. No. 4,941,548, to Blanchard, entitled Fall Arresting Device For Climbers. Although, relative to the Soloist, the Silent Partner has the advantage of not being a directional device, this advantage comes at a significant price. The Silent Partner has a rotably mounted drum with an internal centrifugal clutch assembly. Relative to most belay devices and other pieces of climbing equipment, the Silent Partner is very expensive, with a suggested retail price of $236.25. A second negative aspect of the Silent Partner is that, because it uses a centrifugal clutch, it does not lock immediately when a climber falls, requiring a certain rate of speed of the rope through the device to be achieved before locking. This aspect can be dangerous because there can be conditions during a climb when even a very short fall of a climber can cause serious injury. A third negative aspect of the Silent Partner is that it is both large and heavy relative to most other belay devices. As a fourth negative aspect, like the Soloist, the Silent Partner does not provide a means for a climber to lower himself if the climber has fallen and has come to rest suspended in mid-air from an overhanging clip.

The devices of the prior art, including those mentioned above, do not disclose, teach or illustrate the unique structure, function and advantage of the subject Self-Belay And Rappel Device.

### SUMMARY

The essence of the present invention is a climber's self-belay and rappel device, particularly suited for solo lead climbing. This directional device is simple to thread with rope, relatively light weight and small in size, inexpensive to manufacture, and locks the rope very quickly in the event of a fall by a climber. The device can be used as a rappel device in either of two configurations, one of which allows the rope to be threaded through the device in the same manner as when using the device for fall arrest. A climber can therefore use the device to lower himself after a fall, even after having come to rest suspended in mid-air from an overhanging clip.

### OBJECTS AND ADVANTAGES

An object of the subject invention is a self-belay device that is relatively inexpensive to manufacture. The device basically consists of two plates, each with multiple holes, which are held apart from each other. The form for the plates, and all holes, can be stamped from sheet metal. Simple cylindrical stand-offs can be employed to separate the plates.

Another object is a self-belay device that also functions as a rappel device.

Another object is a self-belay and rappel device that is light weight.

Another object is a self-belay and rappel device, and method of use, that will allow a climber to lower himself/herself along a rope after the device has arrested the fall of the climber and the climber has come to rest suspended in mid-air.

Another object is a self-belay and rappel device that is compact in size.

Another object is a self-belay device that is relatively easy to thread with rope.

### DRAWING FIGURES

FIG. 1 presents a first perspective view of a Self-Belay And Rappel Device.

FIG. 2 presents a second perspective view of the Self-Belay And Rappel Device.

FIG. 3 presents a Second Embodiment Self-Belay And Rappel Device.

FIG. 4 illustrates the Self-Belay And Rappel Device threaded with Rope and configured so as to be used as a self-belay device for lead climbing.

FIG. 5 illustrates how the Self-Belay And Rappel Device arrests the fall of a climber.

FIG. 6 illustrates one configuration allowing a climber to lower himself/herself along the Rope.

FIG. 7 and FIG. 8 illustrate a second method to use the Self-Belay and Rappel Device (10) as a rappel device

### REFERENCE NUMERALS IN DRAWINGS

10 Self-Belay And Rappel Device
12 Left Side Face
14 Right Side Face
16 Cylindrical Stand-Offs
18 Brake Surface
20 Left Upper Karabiner Opening
22 Left Lower Karabiner Opening
24 Left Slot
26 Right Upper Karabiner Opening
28 Right Lower Karabiner Opening
30 Right Slot
32 Second Embodiment Self-Belay And Rappel Device
34 Solid Back Wall
36 Rope
38 Rope Fixed End
40 Rope Free End
42 Chest Harness Attachment Karabiner
44 Waist Harness Attachment Karabiner
46 Braking Karabiner
48 Sling
50 Rope Restraint Karabiner

### DESCRIPTION AND OPERATION

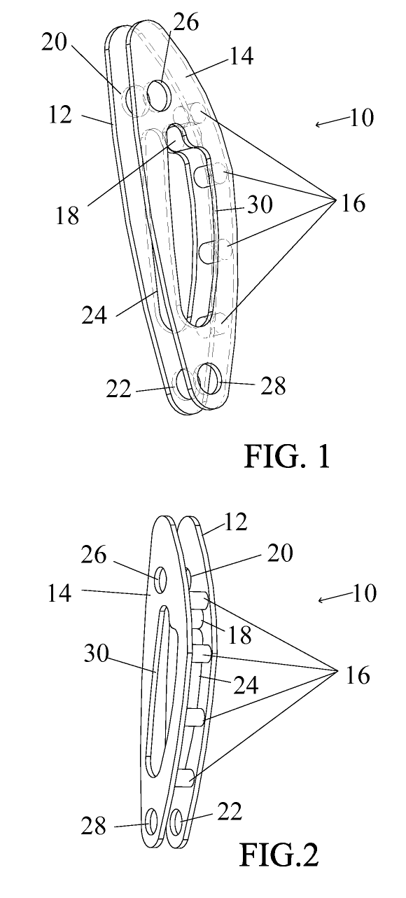

FIGS. 1 and 2 present two perspective views of a Self-Belay And Rappel Device (10) which has a Left Side Face (12), a Right Side Face (14), Cylindrical Stand-Offs (16), and a Brake Surface (18). The Cylindrical Stand-Offs (16) connect to both the Left Side Face (12) and the Right Side Face (14) and separate the Left Side Face (12) and the Right Side Face (14) sufficiently so as to allow passage of a rope between these faces. The Left Side Face (12) has a Left Upper Karabiner Opening (20), a Left Lower Karabiner Opening (22), and a Left Slot (24). The Right Side Face (14) has a Right Upper Karabiner Opening (26), a Right Lower Karabiner Opening (28), and a Right Slot (30). Both the Left Slot (24) and Right Slot (30) extend generally vertically along their respective faces. The Brake Surface (18) extends between the Left Side Face (12) and the Right Side Face (14) and is located near the upper extremes of both the Left Slot (24) and the Right Slot (30).

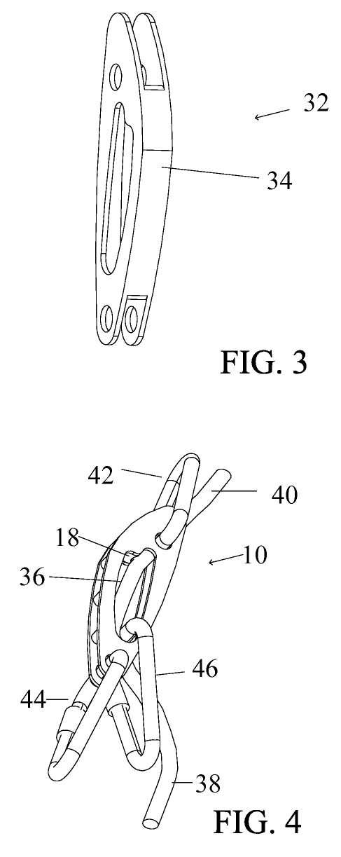

FIG. 3 presents a Second Embodiment Self-Belay And Rappel Device (32) which is otherwise identical to the Self-Belay And Rappel Device (10) with the exception that the Cylindrical Stand-Offs (16) of the Self-Belay And Rappel Device (10) have been replaced by a Solid Back Wall (34). The Cylindrical Stand-Offs (16) of the Self-Belay And Rappel Device (10) and the Solid Back Wall (34) of the Second Embodiment Self-Belay And Rappel Device (32) serve identical functions of providing integrity to the device and maintaining the separation between the Left Side Face (12) and the Right Side Face (14). In certain cases, the Cylindrical Stand-Offs (16) may be preferable in order to decrease the weight of the device.

FIG. 4 shows the Self-Belay And Rappel Device (10) threaded with Rope (36) and configured so as to be used as a self-belay device for lead climbing. The Rope (36) has a Rope Fixed End (38) which leads from the Self-Belay And Rappel Device (10) to a fixed anchor (not shown) and a Rope Free End (40). A Chest Harness Attachment Karabiner (42) (not part of the invention) has been clipped through the Left Upper Karabiner Opening (20) and Right Upper Karabiner Opening (26). In use, the Chest Harness Attachment Karabiner (42) is also clipped to a climber's chest harness (not shown). A Waist Harness Attachment Karabiner (44) (not part of the invention) has been clipped through the Left Lower Karabiner Opening (22) and Right Lower Karabiner Opening (28). In use, the Waist Harness Attachment Karabiner (44) is also clipped to a climber's waist harness (not shown). A Braking Karabiner (46) (not part of the invention) has been clipped through both the Left Slot (24) and Right Slot (30). The Rope (36) is threaded through the Self-Belay And Rappel Device (10) such that the Rope Fixed End (38) is below the device and the Rope Free End (40) is above the device. The Rope (36) is threaded such that, when following the Rope (30) from the top of the device toward the bottom of the device, the Rope (36) passes:
(i) in front of the Brake Surface (18),
(ii) behind an upper portion of the Braking Karabiner (46) residing between the Left Slot (24) and Right Slot (30),
(iii) through the ring of the Braking Karabiner (46),
(iv) in front of a lower portion of the Braking Karabiner (46) residing outside of the device.
   In use, as a climber ascends a climbing route, the Rope (36), passes freely through the Self-Belay And Rappel Device (10), being held fixed at the Rope Fixed End (38). Also as the climber ascends, the climber periodically clips the Rope Fixed End (38) into the rock surface (not shown). If a climber falls, the Self-Belay And Rappel Device (10) will lock on the rope thereby arresting the fall of the climber. The fall of a climber causes the Self-Belay And Rappel Device (10) to drop below the highest point at which the climber has clipped the Rope Fixed End (38) into the rock surface; thus causing the pulling force of the Rope (36) from the Rope Fixed End (38) to change from a generally downward pulling force with respect to the device, to a generally upward pulling force with respect to the device.

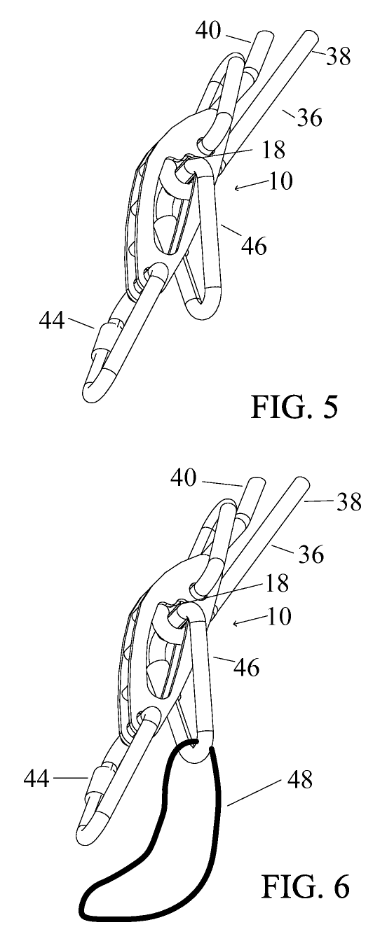

As shown in FIG. 5, a generally upward pulling force exerted on the Self-Belay And Rappel Device (10) by the Rope (36) from the Rope Fixed End (38), such as when a climber falls, causes the Braking Karabiner (46) to move upward along the Left Slot (24) and Right Slot (30), thereby causing a portion of the Rope (36) to become pinched between the Braking Karabiner (46) and Brake Surface (18), thereby locking the device on the Rope (36) and arresting the fall of the climber.

As FIG. 6 illustrates, once the Self-Belay And Rappel Device (10) has locked on the Rope (36), a Sling (48) (not part of the invention) can be attached to the Braking Karabiner (46). The climber can release the pinch force on the Rope (36) in a controlled manner by stepping one foot into the Sling (48) and regulating the downward force exerted by the climber's foot against the Sling (48). The climber can thus lower himself/herself along the Rope (36). This feature of the subject invention is particularly advantageous in that the climber does not need to change the path of the Rope (36) through the device in order to change its function from a fall arrest device to a rappel device. Although other self-belay devices can be used to rappel, they typically require the rope to be threaded differently when going from a belay function to a rappel function. If a climber has already fallen and is suspended from an overhanging clip by a device other than that of the subject invention, he/she cannot undo the Rope (36) from the other device in order to rethread the device to rappel.

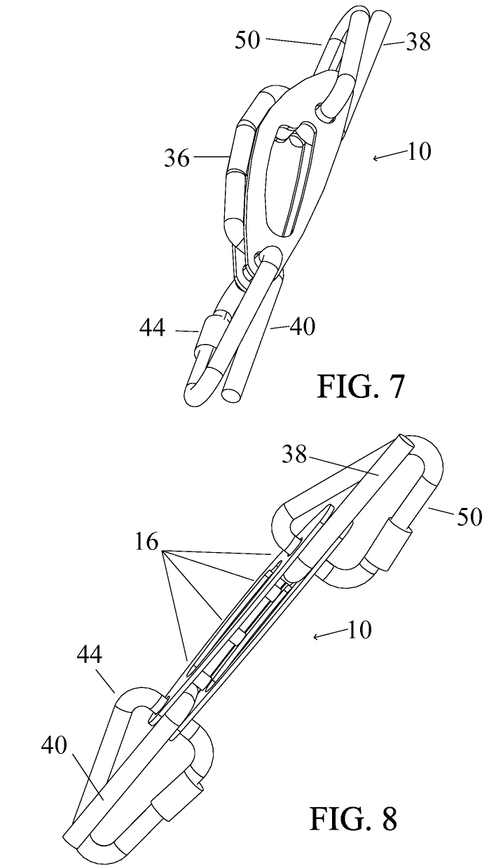

FIGS. 7 and 8 illustrate a second method to use the Self-Belay and Rappel Device (10) as a rappel device, in which the Rope (36) is threaded through the device differently than when using the device as a self-belay device. The device is connected to a waist harness (not shown) just as if it would be if used for self-belay, but the device does not need to be connected to a chest harness (not shown). A Rope Restraint Karabiner (50) (not part of the invention) is clipped through both the Left Upper Karabiner Opening (20) and Right Upper Karabiner Opening (26). The Rope (36) is threaded with the Rope Fixed End (38) passing into the top of the device and the Rope Free End (40) passing out of the bottom of the device. When followed from the top of the device to the bottom of the device, the Rope (36):
(i) passes in front of the Rope Restraint Karabiner (50);
(ii) bends under the bottom of the Rope Restraint Karabiner (50);
(iii) passes between the Left Side Face (12) and the Right Side Face (14) and over the upper most of the Cylindrical Stand-Offs(16);
(iv) bends and proceeds downward along the rear portions of the Cylindrical Stand-Offs (16);
(v) bends under the lower most of the Cylindrical Stand-Offs (16);
(vii) passes between the Left Side Face (12) and the Right Side Face (14) and over the top of the Waist Harness Attachment Karabiner (44);
(viii) bends and extends downward in front of the Waist Harness Attachment Karabiner (44).
   This method of threading the Rope (36) provides sufficient drag, generated by the multiple bends of the Rope (36), so as to allow a climber to easily control his/her rate of descent by the application of force to the Rope Free End (40).

### CONCLUSION, RAMIFICATIONS, AND SCOPE

Thus the reader will see that the subject invention is a self-belay and rappel device, and methods of use, particularly suited for solo lead climbing. The device will arrest the fall of a climber and also provides two modes of use which allow the climber to rappel along a rope. Relative to the prior art, the device has the advantages of:
(i) being simple to thread with rope,
(ii) being relatively inexpensive to manufacture,
(iii) being light in weight,
(iv) being compact in size,
(v) providing two methods for a climber to rappel, one of which allows the climber to lower himself along the rope, even if the climber has come to rest suspended in mid-air after a fall.

While the above description contains many specifics, these should not be construed as limitations on the scope of the invention, but rather as examples of embodiments thereof. Each piece described within the aforementioned embodiments could be changed in form in ways that would not affect its function. Accordingly, the scope of the invention should be determined not by the embodiments illustrated, but by the appended claims and their legal equivalents.

I claim:

1. A self-belay and rappel device, particularly suited for the activity of solo lead climbing, for use in conjunction with a rope, having a fixed end and a free end, and one or more karabiners, to arrest a fall of a climber attached to said rope by said self-belay and rappel device, and/or to allow said climber to descend said rope, comprising:
(a) a left side face;
(b) a right side face;
(c) a face joining means, joining said left side face to said right side face and located toward the back edges of both said left side face and said right side face;
said face joining means dimensioned so as to separate said left side face and said right side face sufficiently to allow the passage of said rope between said left side face and said right side face;
(d) a chest harness attachment means located near the upper extreme of said self-belay and rappel device and enabling said self-belay and rappel device to be attached to a chest harness;
(e) a waist harness attachment means located near the lower extreme of said self-belay and rappel device and enabling said self-belay and rappel device to be attached to a waist harness;
(f) a left slot in said left side face;
(g) a right slot in said right side face;
(h) a rope brake surface;
said left slot and said right slot both of similar shape, located directly across from each other, and extending generally vertically along their respective faces, each of sufficient width to allow passage of a cross section of a karabiner; said rope brake surface extending between said left side face and said right side face and positioned near the upper extremes of both said left slot and said right slot;
when configured for fall arrest use; said self-belay and rappel device having a karabiner positioned through both said left slot and said right slot, and allowing said rope to pass through said self-belay and rappel device when said fixed end of said rope is pulled in one direction with respect to said self-belay and rappel device, but locking said rope against movement when attempting to pull said fixed end of said rope in an opposite direction with respect to said self-belay and rappel device; said locking of said rope caused by compression of said rope between said karabiner and said rope brake surface.

2. The self-belay and rappel device of claim 1 wherein said face joining means comprises a solid wall located at the back of said self-belay and rappel device and connecting said right side face to said left side face.

3. The self-belay device of claim 1 wherein said face joining means comprises one or more cylindrical stand-offs located near the back of said self-belay and rappel device and connecting said right side face to said left side face.

4. The self-belay and rappel device of claim 1 wherein said chest harness attachment means comprises two generally circular chest harness openings, one each in said left side face and said right side face; and wherein said waist harness attachment means comprises two generally circular waist harness openings, one each in said left side face and said right side face; said self-belay and rappel device able to be attached to said chest harness by clipping a karabiner through said chest harness openings and to said chest harness; said self-belay and rappel device able to be attached to said waist harness by clipping a karabiner through said waist harness openings and to said waist harness.

5. A method of self-belaying for use by a climber which comprises the steps of:
(a) providing a device through which a rope, having a fixed end and a free end, may be threaded, said device comprising:
(i) a left side face;
(ii) a right side face;
(iii) a face joining means, joining said left side face to said right side face and located toward the back edges of both said left side face and said right side face; said face joining means dimensioned so as to separate said left side face and said right side face sufficiently to allow the passage of said rope between said left side face and said right side face;
(iv) a chest harness attachment means located near the upper extreme of said device and enabling said device to be attached to a chest harness;
(v) a waist harness attachment means located near the lower extreme of said device and enabling said device to be attached to a waist harness;
(vi) a left slot in said left side face;
(vii) a right slot in said right side face;
(viii) a rope brake surface;
(b) providing a chest harness;
(c) providing a waist harness;
(d) providing three karabiners;
(e) attaching said device to said chest harness using one of said three karabiners functioning as a chest harness attachment karabiner;
(f) attaching said device to said waist harness using a second of said three karabiners functioning as a waist harness attachment karabiner;
(g) clipping the third of said three karabiners, functioning as a braking karabiner, through both said left slot and said right slot such that an upper portion of said braking karabiner resides within said device extending between said left side face and said right side face, and a lower portion of said braking karabiner lies outside of said device;
(h) threading said rope through said device, with said free end of said rope passing into the top of said device and said fixed end of said rope passing out of the bottom of said device; said rope extending vertically through said device between said left side face and said right side face and in front of said face joining means; said rope threaded in such a manner so that when following said rope downward through said device, said rope passes:
(i) in front of said rope brake surface,
(ii) behind said upper portion of said braking karabiner,
(iii) through the ring of said braking karabiner,
(iv) in front of said lower portion of said braking karabiner;
said method allowing said rope to freely pass through said device when said climber ascends a climbing route, but causing said rope to become locked within said device if said climber were to fall, thus arresting said fall; said fall of said climber causing said device to drop below a fixed anchor to which said fixed end of said rope is attached, in turn causing said rope to pull said upper portion of said braking karabiner upward along both said left slot and said right slot, further causing a portion of said rope to become pinched between said upper portion of said braking karabiner and said brake surface; thus arresting said fall of said climber.

6. A method of rappelling for use by a climber which comprises the steps of:
(a) providing a device through which a rope, having a fixed end and a free end, may be threaded, said device comprising:
(i) a left side face;
(ii) a right side face;
(iii) a face joining means, joining said left side face to said right side face and located toward the back edges of both said left side face and said right side face; said face joining means dimensioned so as to separate said left side face and said right side face sufficiently to allow the passage of said rope between said left side face and said right side face;
(iv) a chest harness attachment means located near the upper extreme of said device and enabling said device to be attached to a chest harness;
(v) a waist harness attachment means located near the lower extreme of said device and enabling said device to be attached to a waist harness;
(vi) a left slot in said left side face;
(vii) a right slot in said right side face;
(viii) a rope brake surface;
(b) providing a chest harness;
(c) providing a waist harness;
(d) providing a karabiner to function as a braking karabiner;
(f) providing a flexible sling;
(e) attaching said device to said chest harness using said chest harness attachment means;
(f) attaching said device to said waist harness using said waist harness attachment means;
(g) clipping said braking karabiner through both said left slot and said right slot such that an upper portion of said braking karabiner resides within said device extending between said left side face and said right side face, and a lower portion of said braking karabiner lies outside of said device;
(h) attaching said flexible sling to said braking karabiner either by means of a girth hitch or by clipping said flexible sling into said braking karabiner;
(i) threading said rope through said device, with said free end of said rope passing into the top of said device and said fixed end of said rope passing out of the bottom of said device; said rope extending vertically through said device between said left side face and said right side face and in front of said face joining means;
said rope threaded in such a manner so that when following said rope downward through said device, said rope passes:
(i) in front of said rope brake surface,
(ii) behind said upper portion of said braking karabiner,
(iii) through the ring of said braking karabiner,
(iv) in front of said lower portion of said braking karabiner;
(j) said climber resting all of his/her weight on said device thereby causing said device to lock said rope by pinching said rope between said braking karabiner and said brake surface;
(k) said climber then placing a foot in said sling and exerting downward force against said sling; said downward force thus tending to pull said braking karabiner away from said braking surface thus decreasing the net force pinching said rope between said braking karabiner and said braking surface;
said climber thus being able to descend said rope and to control the rate of his/her descent by controlling the amount of said downward force exerted on said sling.

7. A method of rappelling for use by a climber which comprises the steps of:
(a) providing a device through which a rope, having a fixed end and a free end, may be threaded, said device comprising:
(i) a left side face;
(ii) a right side face;
(iii) a face joining means, joining said left side face to said right side face and located toward the back edges of both said left side face and said right side face; said face joining means dimensioned so as to separate said left side face and said right side face sufficiently to allow the passage of said rope between said left side face and said right side face;
(iv) two generally circular upper karabiner openings, one each in said left side face and said right side face; each located near the upper extreme of said device;
(v) two generally circular lower karabiner openings, one each in said left side face and said right side face; each located near the lower extreme of said device;
(vi) a left slot in said left side face;
(vii) a right slot in said right side face;
(viii) a rope brake surface;
(b) providing a waist harness;
(c) providing two karabiners;
(d) attaching said device to said waist harness using one of said two karabiners, functioning as a waist harness attachment karabiner, by clipping said waist harness attachment karabiner through said two generally circular lower karabiner openings and into said waist harness;
(e) clipping the second of said two karabiners, functioning as a rope restraint karabiner, through said two generally circular upper karabiner openings;
(f) threading said rope through said device, with said fixed end of said rope passing into the top of said device and said free end of said rope passing out of the bottom of said device; when followed from said top of said device to said bottom of said device, said rope;
(i) passing in front of said rope restraint karabiner;
(ii) bending under the bottom of said rope restraint karabiner;
(iii) passing between said left side face and said right side face and over the upper most portion of said face joining means;
(iv) bending and proceeding downward along the rear portion of said face joining means;
(v) bending under the lower most portion of said face joining means;
(vii) passing between said left side face and said right side face and over the top of said waist harness attachment karabiner;
(viii) bending and extending downward in front of said waist harness attachment karabiner;
sufficient drag being thus generated by the multiple bends of said rope so as to allow said climber to easily control his/her rate of descent by the application of force to the end of said rope below said device.
